(19) United States
(12) Patent Application Publication
(10) Pub. No.: US 2026/0064446 A1
(43) Pub. Date: Mar. 5, 2026

(54) Auto-Generated Video Tutorials

(71) Applicant: Avaya Management L.P., Santa Clara, CA (US)

(72) Inventors: Adrian Walsh, Galway (IR); Michael Smyth, Galway (IR); Ronan McCaffrey, Galway (IR)

(73) Assignee: Avaya Management L.P., Santa Clara, CA (US)

(21) Appl. No.: 18/817,009

(22) Filed: Aug. 27, 2024

(51) Int. Cl. G06F 9/451; G06F 40/205; G06F 40/58; G10L 13/08; G11B 27/10

(52) U.S. Cl. CPC G06F 9/453; G06F 40/205; G06F 40/58; G10L 13/08; G11B 27/10

(57) ABSTRACT

Embodiments provide methods and systems for generating automated video tutorials. The methods and system include receiving, by a processor, a test script document, wherein the test script document includes element identifiers, test steps and test text parsing, by the processor, the test script document to identify the element identifiers, the test steps and the test text and generating, by the processor, a video component based on the identified element identifiers, the identified test steps and the identified test text. The methods and systems further include generating, by the processor, an audio component based on the identified element identifiers, and the identified test text and synchronizing, by the processor, the video component and the audio component based on the identified element identifiers.

### BACKGROUND

The present disclosure is generally directed to user interfaces and, in particular, towards systems and methods for generating video tutorials with synchronized sound.

Computer systems, such as personal computers and smartphones, execute user applications in which users interact with graphical user interface (GUI) elements displayed on a user interface. Such applications include, for example, Internet browsers used to view websites and applications such as word processing applications. Applications can include those that execute on the same computing devices on which users interact with the applications, like applications running on computing devices such as smartphone, tablet, and more traditional laptop and desktop computing devices. The applications can further include those that primarily execute on one computing device, like a server computing device, and with which users interact via another computing device, like a client computing device that may be a smartphone, tablet, or a more traditional computing device. The latter applications can include web applications, or web apps, which can run within web browser programs on the client side.

When a new application (or software tool) is deployed or updated, there may be a desire to train users how to use the new application or new features of a previous version of an application. Tutorial videos may be useful to visualize and learn how to use new features of an application or website. As the software used to execute such user applications is developed and updated over time, new features are often added. With new features, new tutorial videos may be created.

### SUMMARY

While tutorial videos are a great benefit to end users, the creation of tutorial videos is often a time consuming and inefficient process. For example, a software developer may execute a screen capture application to record his or her screen, including mouse movements and the entry of text, to illustrate a new feature. The developer may use a voice recording software to talk through the steps being performed. This voice over feature is not desirable since the generated audio does not necessarily correspond with the user's screen, the user's text entry and/or the user's mouse movements in the screen capture video. The screen capture video must typically be edited to remove mistakes or unnecessary time delays. Similarly, the audio of the developer talking through the steps may be edited or replaced with the recording of additional audio. Furthermore, with each new iteration of a new feature or changes in an application or website, older tutorial videos must be updated or recreated, resulting in a highly inefficient process for showing end users how to use an application or website.

These and other needs are addressed by the various embodiments and configurations of the present invention. The present invention can provide a number of advantages depending on the particular configuration. These and other advantages will be apparent from the disclosure of the invention(s) contained herein.

In some aspects, the techniques described herein relate to a method for generating automated video tutorials including receiving, by a processor, a test script document, wherein the test script document includes element identifiers, test steps and test text; parsing, by the processor, the test script document to identify the element identifiers, the test steps and the test text; generating, by the processor, a video component based on the identified element identifiers, the identified test steps and the identified test text; generating, by the processor, an audio component based on the identified element identifiers, and the identified test text; and synchronizing, by the processor, the video component and the audio component based on the identified element identifiers.

In some aspects, the techniques described herein relate to a method, further including generating, by the processor, the audio component using text-to-speech.

In some aspects, the techniques described herein relate to a method, further including receiving, by the processor, the test script document includes at least one of receiving the test script document via a network or receiving the test script document from a storage location at an associated address.

In some aspects, the techniques described herein relate to a method, wherein the test script document is a text-based data structure.

In some aspects, the techniques described herein relate to a method, further including prior to generating, by the processor, the audio component based on the identified element identifiers and the identified test text, receiving a selection of one or more languages.

In some aspects, the techniques described herein relate to a method, further including translating, by the processor, the test text based on the received selection of the one or more languages.

In some aspects, the techniques described herein relate to a method further including generating, by the processor, the audio component based on the translated test text based on the received selection of the one or more languages.

In some aspects, the techniques described herein relate to a computer system, including a processor and a computer-readable storage medium storing computer-readable instructions, which when executed by the processor, cause the processor to receive a test script document, wherein the test script document includes element identifiers, test steps and test text;
parse the test script document to identify the element identifiers, the test steps and the test text; generate a video component based on the identified element identifiers, the identified test steps and the identified test text; generate an audio component based on the identified element identifiers, and the identified test text; and synchronize the video component and the audio component based on the identified element identifiers.

In some aspects, the techniques described herein relate to a computer system, wherein the computer-readable instructions, when executed by the processor, further cause the processor to generate the audio component using text-to-speech.

In some aspects, the techniques described herein relate to a computer system, wherein the computer-readable instructions, when executed by the processor, further cause the processor to receive a test script document includes at least one of receiving the test script document via a network or receiving the test script document from a storage location at an associated address.

In some aspects, the techniques described herein relate to a computer system, wherein the test script document is a text-based data structure.

In some aspects, the techniques described herein relate to a computer system, wherein the computer-readable instructions, when executed by the processor, further cause the processor to prior to generate the audio component based on the identified element identifiers and the identified test text, receive a selection of one or more languages.

In some aspects, the techniques described herein relate to a computer system, wherein the computer-readable instructions, when executed by the processor, further cause the processor to translate the test text based on the received selection of the one or more languages.

In some aspects, the techniques described herein relate to a computer system, wherein the computer-readable instructions, when executed by the processor, further cause the processor to generate the audio component based on the translated test text based on the received selection of the one or more languages.

In some aspects, the techniques described herein relate to a computer program product, including a computer-readable storage medium having computer-readable program code embodied therewith, the computer-readable program code configured, when executed by a processor, to receive a test script document, wherein the test script document includes element identifiers, test steps and test text; parse the test script document to identify the element identifiers, the test steps and the test text; generate a video component based on the identified element identifiers, the identified test steps and the identified test text; generate an audio component based on the identified element identifiers, and the identified test text; and synchronize the video component and the audio component based on the identified element identifiers.

In some aspects, the techniques described herein relate to a computer program product, wherein the computer-readable program code, when executed by the processor, further causes the processor to generate the audio component using text-to-speech.

In some aspects, the techniques described herein relate to a computer program product, wherein the computer-readable program code, when executed by the processor, further causes the processor to receive the test script document includes at least one of receiving the test script document via a network or receiving the test script document from a storage location at an associated address.

In some aspects, the techniques described herein relate to a computer program product, wherein the test script document is a text-based data structure.

In some aspects, the techniques described herein relate to a computer program product, wherein the computer-readable program code, when executed by the processor, further causes the processor to, prior to generate the audio component based on the identified element identifiers and the identified test text, receive a selection of one or more languages.

In some aspects, the techniques described herein relate to a computer program product, wherein the computer-readable program code, when executed by the processor, further causes the processor to translate the test text based on the received selection of the one or more languages.

A system on a chip (SoC) including any one or more of the above aspects or aspects of the embodiments described herein.

One or more means for performing any one or more of the above or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above aspects or aspects of the embodiments described herein, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,”“including,”and “having”can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, radio frequency (RF), etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

FIG. 1 is a block diagram of an illustrative system for generating video tutorials with synchronized audio and video components according to an embodiment of the present disclosure;

FIG. 2 is a block diagram of a computing device in accordance with embodiments of the present disclosure;

FIG. 3 illustrates an example user interface of an application in accordance with embodiments of the present disclosure;

FIG. 4 illustrates an example system diagram with example features of a computerized training video system in accordance with embodiments of the present disclosure;

FIG. 5 depicts a flow diagram depicting a method for automatically generating a video tutorial with synchronized audio and video components in accordance with embodiments of the present disclosure; and

FIG. 6 depicts an example test script document used for automatically generating a video tutorial with synchronized audio and video components in accordance with embodiments of the present disclosure.

Whenever possible, the same reference numbers will be used throughout the drawing(s) and accompanying written description to refer to the same of like parts.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, it is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

As discussed in the background, video tutorials are a great benefit to end users, but the creation of video tutorials is a time-consuming process. What is needed is an automated system for creating video tutorials which may be used by software or web developers to automatically create new video tutorials with any new update to features of an application or website where the video images and the audio are synchronized.

The systems and methods described herein involve creating video tutorials for applications or websites or any type of system in which users interact with graphical user interface (GUI) elements displayed on a user interface. For simplicity of explanation, the term application as used herein may refer to a computer application, a mobile application, a website, or any other type of computer system involving software and GUI elements.

As noted in the background, when using an application, users interact with GUI elements displayed by the application to cause the application to perform a desired function. There is a large variety of GUI elements which can be deployed by an application. For example, GUI elements used by an application may include, but are not limited to, text boxes which can be selected by a user which can allow text to be entered, radio buttons, dropdown list boxes that permit the user to select from one or more different options corresponding to the radio buttons and list box items, and checkboxes that permit a user to select from multiple options corresponding to the checkboxes. As other non-exhaustive examples, GUI elements can include toggle switches that permit the user to select from two options, and action buttons that the users can affirmatively select to perform actions like submit, cancel, and so on.

As described herein, systems and methods may include a method of generating video tutorials for a client application autonomously or with or without the aid of a human developer. The systems and methods described herein amount to a tool for making video tutorials in such a way as to make the creation of video tutorials more efficient and user friendly than before. Using these systems and methods described herein, a developer may be enabled to create video tutorials more quickly, accurately, and easily than before with the video components and the audio components being synchronized.

As described herein, a developer application may be used to create a video tutorial for a client application. The developer application may also be referred to as a test tool which runs a test script in order to generate the video tutorial. The client application may also be referred to as an application under test (“AUT”). As described herein, an AUT may be a web application or a native application. An AUT may be any type of computer software that employs GUI elements or other user-interactive elements.

In general, a video tutorial may be a set of still images and/or video clips in the form of a video file. Each still image or video clip may be a scene of a video tutorial generated using the test script. Each scene of a video tutorial may include an illustration of an action (e.g., test step) which a user may perform using a GUI element of a UI along with a synchronized auto explanation and/or a textual explanation (e.g., test text). Each GUI element includes a GUI element identifier. The GUI element identifier is provided in the test script which is used to generate the video clip and the synchronized audio from the textual explanation using text-to-speech processing. For example, a video tutorial may include a scene instructing a user to open up a browser. The scene may include the words “The Agent is logged in and Ready” along with a still image of a mouse cursor over the browser or with a video of the browser being clicked. The words are converted into speech using text-to-speech processing and are synchronized with the still image of the mouse cursor over the browser or with the video of the browser clicked based on the GUI element identifier for the browser provided in the test script which is used to generate the still image or video clip and the synchronized audio. Although not shown to the user, the GUI element identifier for the browser displayed on the user interface is the same as the GUI element identifier for the browser identified in the test script. The video tutorial may also include a title scene, an introduction scene, added grammar around the test steps, an end scene, and other elements based on the GUI element identifier.

The developer application may be a software application in which a user may load or access an AUT. As described herein, the user may open the developer application and select an AUT for which to create a video tutorial. A user interface of the AUT may be displayed alongside a user interface of the test tool. The user may use the developer application, as described below, to select a set of actions which are to be illustrated in the video tutorial.

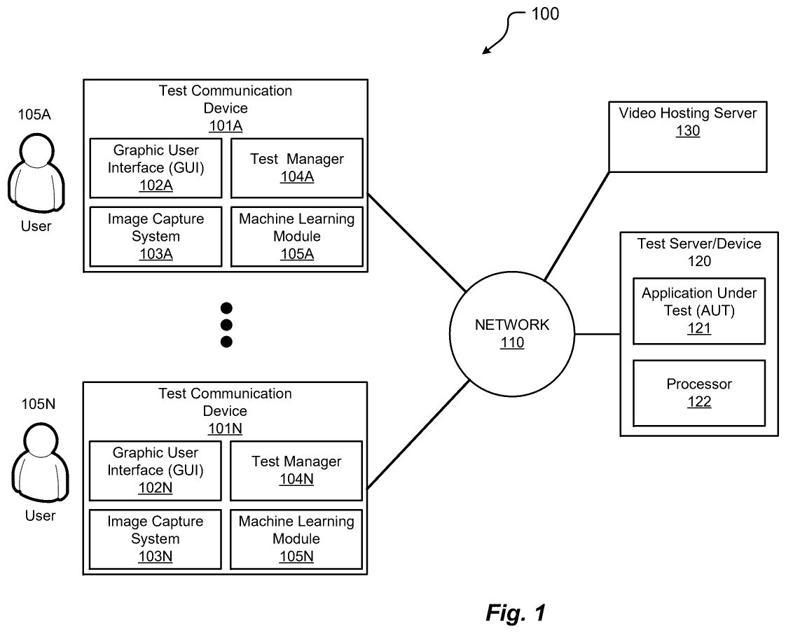

FIG. 1 is a block diagram of an illustrative system 100 for generating video tutorials with synchronized audio and video components according to an embodiment of the present disclosure. The system 100 may be accessed by one or more users 105A-105N using the corresponding one or more test communication devices 101A-101N. The illustrative system 100 may include the users 105A-105N, the test communication devices 101A-101N, a network 110, a video hosting server 130, and a test server/device 120.

Test communication devices 101A-101N can be or may include any user communication endpoint device that can communicate on the network 110, such as a Personal Computer (PC), a tablet device, a notebook device, a smart phone, and/or the like. Test communication devices 101A-101N may be used to access any one or more of the video hosting server 130 and the test server/device 120. As shown in FIG. 1, any number of test communication devices 101A-101N may be connected to the network 110.

The test communication devices 101A-101N each includes a graphical user interface 102A-102N, an image capture system 103A-103N, a test manager 104A-104N, and a machine learning module 105A-105N. The graphical user interface 102A-102N can be any graphical user interface 102A-102N that can display graphical information provided by the application 121. For example, the graphical user interface 102A-102N may display graphical information of a browser.

The image capture system 103A-103N is used to capture an image of the graphical user interface 102A-102N. The image capture system 103A-103N may include a camera that captures the graphical user interface 102A-102N. Alternatively, the image capture system 103A-103N may analyze graphical data being sent for display on the test communication device 101A-101N in the graphical user interface 102A-102N. The image capture system 103A-103N uses a display screen of the graphical user interface 102A-102N to detect changes in the graphical user interface 102A-102N. For example, the image capture system 103A-103N may analyze different frames of the display screen to identify changes in the graphical user interface 102A-102N.

The test manager 104A-104N is used to identify actionable graphical objects in the graphical user interface 102A-102N based on the detected changes to the graphical user interface 102A-102N. An actionable graphical object is a graphical object where a mouse click on the actionable graphical object causes an event. For example, an actionable graphical object may be a button, a scroll bar, a check box, an icon, a link, a tab, a menu, a menu item, a text field, a text area, a slider, a control, and/or the like. The test manager 104A-104N uses the results of detection of actionable graphical objects to run tests against the application under test 121.

The machine learning module 105A-105N may use a variety of machine learning algorithms, such as, supervised machine learning, unsupervised machine learning, reinforcement machine learning, semi-supervised machine learning, self-supervised machine learning, multi-instance machine learning, inductive machine learning, deductive machine learning, transductive machine learning, and/or the like. The machine learning module 105A-105N may be used to learn, over time, which graphical objects that are actionable graphical objects.

Although not illustrated, the test communication devices 101A-101N may further include a processor, a test program and a code execution module. The processor can be, or may include, any kind of processor that can process computer code, such as, a hardware processor, a microprocessor, a micro controller, a multi-core processor, an application specific processor, a virtual machine, and/or the like.

The test program can be, or may include, any software/hardware that can generate test(s) for testing the application under test 121. The test program can be written in various programming languages, such as, C, C++, Java, JavaScript, Hyper Text Markup Language (HTML), PERL, and/or the like. The test program may include any of the test scripts/Application Programming Languages (APIs)/text syntax described herein in conjunction with any known programming languages.

The code execution module can be, or may include, any hardware/software that can be used to execute the test program. The code execution module may run any developed test scripts/test programs using the text syntax/APIs described herein. The code execution module may be a code interpreter, may execute code that has been compiled into binary code, and/or the like.

The network 110 can be or may include any collection of communication equipment that can send and receive electronic communications, such as the Internet, a Wide Area Network (WAN), a Local Area Network (LAN), a Voice over IP Network (VoIP), a combination of these, and the like. The network 110 can use a variety of electronic protocols, such as Ethernet, Internet Protocol (IP), Session Initiation Protocol (SIP), Integrated Services Digital Network (ISDN), and the like. Thus, the network 110 is an electronic communication network configured to carry messages via packets and/or circuit switched communications.

The video hosting server 130 can be or may include any hardware system that can facilitate communications on the network 110, such as a session manager, a communication manager, a proxy server, a Private Branch Exchange (PBX), a central office switch, a router, and/or the like. The video hosting server 130 may include one or more memory storage elements capable of storing audio and/or video information as described herein.

The test server/device 120 can be or may include any hardware system that can host applications 121, such as a web server, a media server, and/or the like. In one embodiment of the present disclosure, the test server/device 120 may be part of the video hosting server 130. The test server/device 120 may also include a processor 122.

The application(s) 121 can be any application to be used as an AUT to create a tutorial video, such as a recording application, a calendar application, a video application, a web browser application, an Instant Messaging application, an email application, a call screening application, a conferencing application, and/or the like. As described herein, application may also refer to a website or mobile application. The application(s) 121 may communicate via an Application Programming Interface (API). For example, the API may be an Extended Markup Language (XML) interface, a Java Speech API (JSAPI) application, and/or the like.

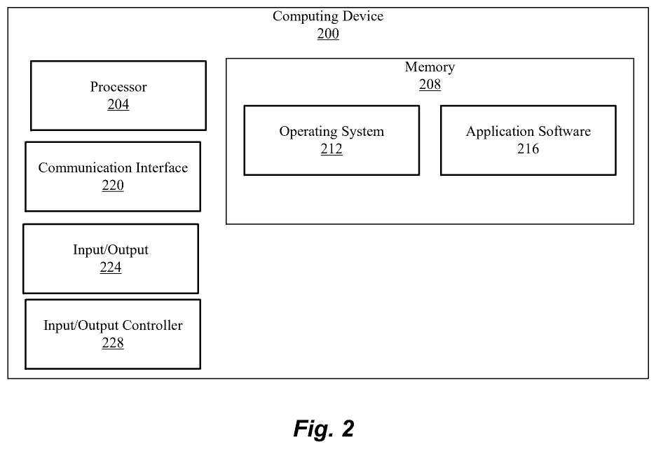

FIG. 2 is a block diagram of a computing device 200 in accordance with embodiments of the present disclosure. In FIG. 2, the computing device 200 may implement some or all of the computerized training video systems described herein. In some embodiments of the present disclosure, components of the computing device 200 may be implemented as a part of an electronic device according to one or more embodiments described in this specification. The computing device 200 may include one or more processors 204 which may be microprocessors, controllers or any other suitable type of processors for processing computer-executable instructions to control the operation of the electronic device. Platform software including an operating system 212 or any other suitable platform software may be provided on the computing device 200 to enable application software 216 to be executed on the device.

Computer-executable instructions may be provided using any computer-readable media that are accessible by the computing device 200. Computer-readable media may include, for example, computer storage media such as a memory 208 and communications media. Computer storage media, such as a memory 208, includes volatile and non-volatile, removable and non-removable media implemented in any method or technology for storage of information such as computer-readable instructions, data structures, program modules or the like. Computer storage media include, but are not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Propagated signals per se are not examples of computer storage media. Although the computer storage medium (the memory 208) is shown within the computing device 208, it will be appreciated by a person skilled in the art, that the storage may be distributed or located remotely and accessed via a network or other communication link (e.g., using a communication interface 220).

The computing device 200 may include an input/output controller 228 configured to output information to one or more output devices 224, for example, a display or a speaker, which may be separate from or integral to the electronic device. The input/output controller 228 may also be configured to receive and process an input from one or more input devices 224, for example, a keyboard, a microphone or a touchpad. In one embodiment, the output device 224 may also act as the input device. An example of such a device may be a touch-sensitive display. The input/output controller 228 may also output data to devices other than the output device, e.g., a locally connected printing device. In some embodiments of the present disclosure, a user may provide input to the input device(s) 224 and/or receive output from the output device(s) 224.

The functionality described herein can be performed, at least in part, by one or more hardware logic components. According to an embodiment of the present disclosure, the computing device 200 is configured by the program code when executed by the processor 204 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

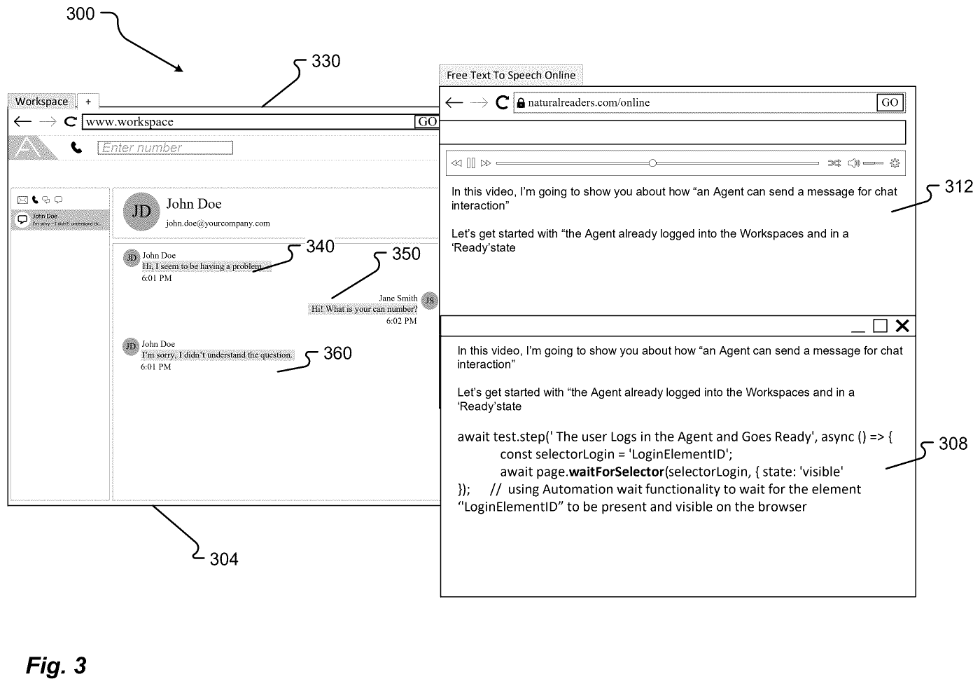

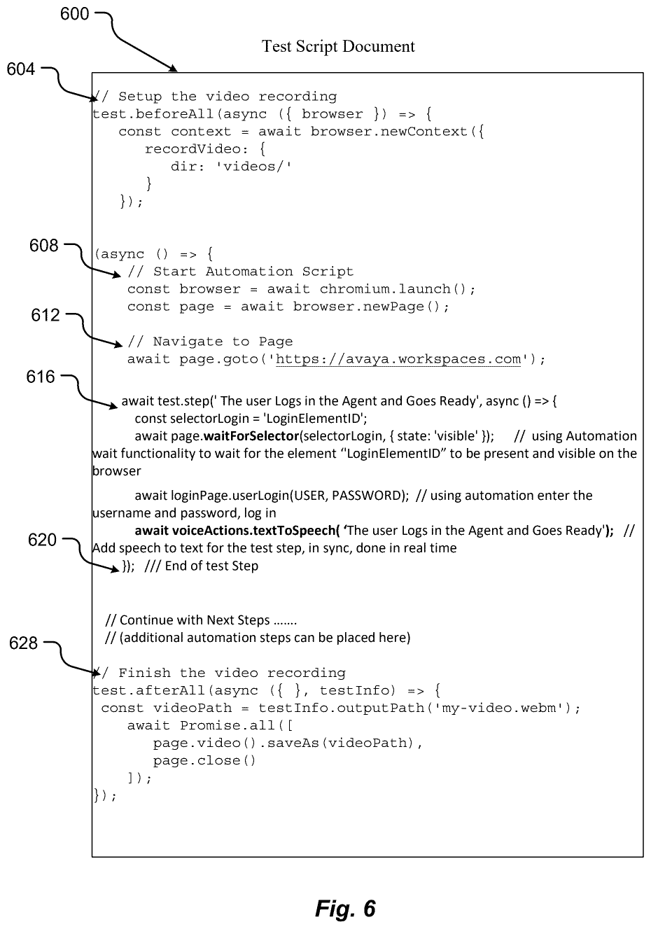

FIG. 3 illustrates an example user interface 300 of an application in accordance with embodiments of the present disclosure. A developer application may include a user interface 300 as illustrated in FIG. 3. The user interface 300 may include a developer test script pane 308, a developer test text pane 312 and a client application or AUT interface pane 304. The developer test script pane 308 includes the test script which includes test steps, test text, and the GUI element identifiers. As an example, the developer test script pane 308 includes a test step in the test script identifying a GUI element identifier “LoginElementID” which corresponds to a GUI element identifier appearing in a browser of a webpage, for example. The test steps provided in the developer test script pane 308 are further described in FIG. 6. The developer test text pane 312 includes the test text provided from the test script.

According to an embodiment of the present disclosure, synchronization between video and audio is performed using the GUI element identifiers. The GUI element identifiers are provided within the test script. Once the GUI element identifier appears on a page of the test script, audio is created from the associated text within the test script. Therefore, the GUI appearing in the video will be synchronized with the speech describing what is shown in the video in real time. For example, the processor 122 of the test server/device 120 could start the automation of the test script. According to embodiments of the present disclosure, this may include initializing an automation framework and opening a browser (e.g., any automation framework, playwright, puppeteer, or any other standard automation frameworks). Afterwards, the process directs the browser to a specified URL. Afterwards, the process waits for the GUI to be displayed. According to an embodiment of the present disclosure, a selector can be used to identify the GUI (e.g., the GUI for Login). Moreover, an automation wait functionality can be employed to wait for the GUI to be displayed. Once the GUI has been located and is visible, the username and password could be entered, for example.

According to an embodiment of the present disclosure, a click action can be executed for one step in the test script (e.g., the user logs in). Along with the user logging in, the text associated with “the user logs in” is converted into speech at this same time the step of the user logging in is displayed in the video. The remainder of the steps included in the test script are performed with the synchronization of the speech, converted from the text in the test script, for each of the steps. The automated test script ends with the browser being closed. The video of the steps being performed based on the test script and the synchronized speech is saved and the video is subsequently published.

Text-to-speech technology is used to translate the written text into audible sound. According to embodiments of the present disclosure, a language translator can be provided which translates text in one language into speech in another language. For example, the test text of the test script may be written in English, but translated into spoken French, Spanish or German.

The AUT interface pane 304 may include a display of a user interface of the AUT as if the user of the developer application is using the AUT itself. In some embodiments of the present disclosure, upon opening the developer application, a user may be presented with a menu for selecting an AUT for which to develop a video tutorial. The user may select from among a selection of AUTs or may load an AUT in another way. While the AUT of FIG. 3 is illustrated as a webpage, it should be appreciated the AUT can be any type of application, for example a word processing application or an instance of a developer application as described herein. As illustrated, GUI elements may include browser 330 and input fields 340-360.

The GUI element identifiers for the browser 330 and the input fields 340-360 correspond to the GUI element identifiers provided in the text script for automatically generating a video tutorial with synchronized audio and video components. In some embodiments of the present disclosure, as illustrated in FIG. 3, the developer test script pane 308 may include a play steps button and record buttons. The play steps button may prompt the developer application to automatically proceed through the steps provided in the test script, performing each action. For example, the developer application may be capable of automatically performing the step of opening the browser 330 illustrated in the AUT interface pane 304 and provide the corresponding speech of “Open the browser” (using the text-to-speech feature of the developer test text pane 312) using the GUI element identifier provided in the AUT interface pane 304 and the test script. The developer application may automatically move the mouse cursor in the AUI interface pane 304 while performing the actions of the script. The performance of the step synchronized with the audio may be recorded.

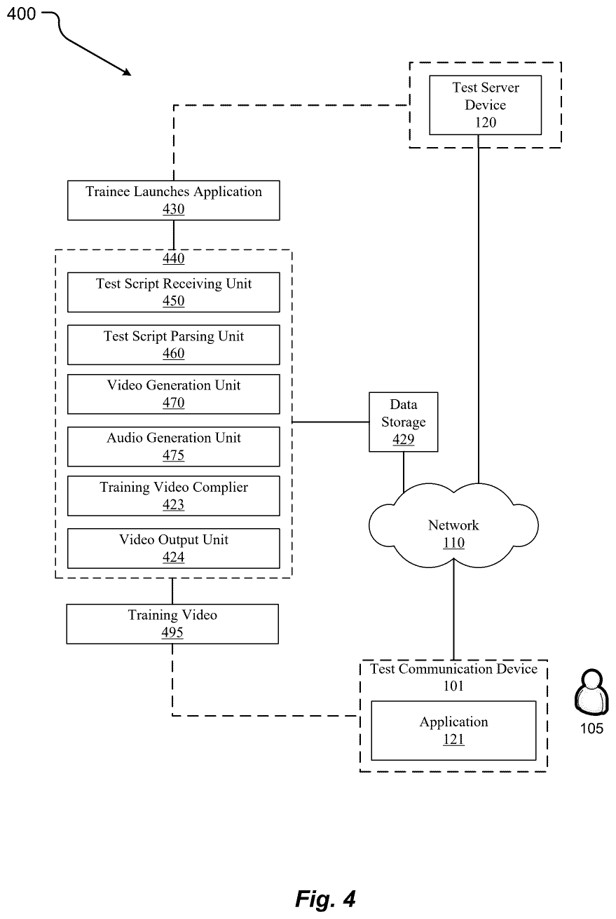

FIG. 4 illustrates an example system diagram 400 with example features of a computerized training video system in accordance with embodiments of the present disclosure. The system diagram 400 in FIG. 4 shows a user or trainee 105 who is executing an application 121 at a test communication device 101. The system diagram 400 further includes a network 110 and a test/server device 120 similar to the components illustrated in FIG. 1 and a data storage 429. The application 121 may be a new application or a new version of an updated application. A computerized training video system 440 may detect when the trainee 105 launches the application (shown at block 430). In some embodiments of the present disclosure, the application 121 itself may invoke the computerized training video system 440—either automatically when launched or in response to a user input requesting training. In other implementations, a helper application or utility (not shown) on the test communication device 101 may detect when the application 121 is launched and invoke the computerized training video system 440. The computerized training video system 440 may be implemented at the test communication device 101 or may be implemented at another machine. Upon detecting that the trainee 105 has launched the application, the computerized training video system 440 may generate and provide a training video 495 to the trainee 105. For example, the computerized training video system 440 may stream the training video via the network 110 (if the computerized training video system 440 is implemented on a separate machine). If the computerized training video system 440 is implemented at the test communication device 101, the computerized training video system 440 may present the training video 495 on an output device (such as a monitor, display, speakers, or a combination thereof) of the test communication device 101.

FIG. 4 shows some example components of the computerized training video system 440 to aid in understanding how the training video 495 is produced. The computerized training video system 440 may include a test script receiving unit 450. For example, the test script receiving unit 450 may receive the test script via a message from the application 121. In some implementations, the application 121 may be a web-based application and may have the test script encoded or linked in the web-based application. As an example, the application 121 may include hypertext markup language (HTML) that includes or links to the test script. When the application 121 is accessed, the web-based application may send the test script to the test script receiving unit 450.

A test script parsing unit 460 of the computerized training video system 440 may process the test script to determine video clip generation instructions. An example of the test script document is described further in FIG. 6. The test script may include multiple user interface flows which describe how to use a particular user interface feature of the application 121. Each user interface flow may include one or more actions or training objectives. The computerized training video system 440 includes a video portion generation unit 470, an audio portion generation unit 475 and training video compiler 480 which together produce the training video by synchronizing the video components with the audio components based on the GUI element identifiers provided in the test script and the user application user interface. The video generation unit 470 may use different video components and the audio generation unit 475 may use different audio components to create video clips of the actions in the user interface flows. In one example, the video generation unit 470 and the audio generation unit 480 may include a UI automation unit that simulates actions on an application instance and records screen capture or video output from the application instance. Alternatively, the video generation unit 470 may generate video based on still images (such as screenshots, overlay images, or the like). In one example, the audio may be generated by a text-to-speech converter that produces audio content based on test text and the GUI element identifier provided in the test script. The training video compiler 480 may compile multiple video clips to produce the training video 495. A video output unit 490 may provide the training video 495 to the trainee 105. In some implementations, the computerized training video system 440 may store all or part of the training video for subsequent use in preparing training videos for user interface flows that are unchanged.

FIG. 6 depicts an example test script document 600 used for automatically generating a video tutorial with synchronized audio and video components in accordance with embodiments of the present disclosure. The test script document 600 includes steps including: (1) set up the video recording 604; (2) start automation test script 608; (3) navigate to webpage 612; (4) await test step 616; (5) end of test step 620; (6) continue with next test steps 624; and (7) finish video recording 628. As illustrated in step 4, the GUI element identifier for “Login” is “Login ElementID” as discussed above in FIG. 3.

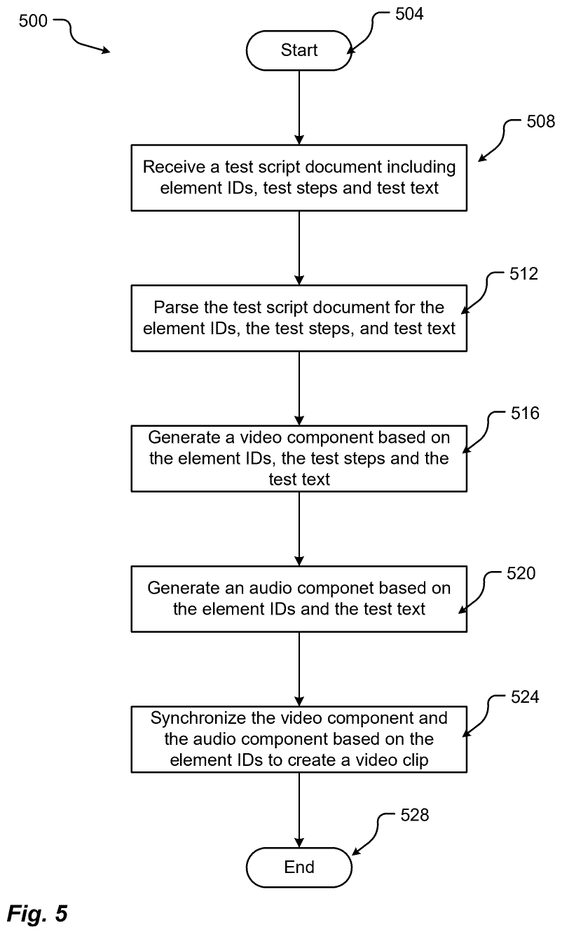

FIG. 5 depicts a flow diagram depicting a method 500 for automatically generating a video tutorial with synchronized audio and video components in accordance with embodiments of the present disclosure. While a general order of the steps of method 500 is shown in FIG. 5, method 500 can include more or fewer steps or can arrange the order of the step differently than those shown in FIG. 5. Further, two or more steps may be combined in one step. Generally, method 500 starts at a START operation at step 504 and ends with an END operation at step 528. Method 500 can be executed as a set of computer-executable instructions executed by a computer system (e.g., the test communication device(s) 101, the test/server device 120, the processor 204, etc.) and encoded or stored on a computer readable medium (e.g., memory 208, etc.). Hereinafter, method 500 shall be explained with reference to the systems, components, modules, applications, software, data structures, user interfaces, etc. described in conjunction with FIGS. 1-4 and 6.

As illustrated in FIG. 5, method 500 begins at the START operation at step 504 and proceeds to step 508, where the processor 204 of the test communication devices 101 or the test/server device 120 receives a test script document including element IDs, test steps and test text.

After the processor 204 of the test communication devices 101 or the test/server device 120 receives a test script document including element IDs, test steps and test text at step 508, method 500 proceeds to step 512, where the processor 204 of the test communication devices 101 or the test/server device 120 parses the test script document for the element IDs, the test steps and the test text. After the processor 204 of the test communication devices 101 or the test/server device 120 parses the test script document for the element IDs, the test steps and the test text at step 512, method 500 proceeds to step 516, where the processor 204 of the test communication devices 101 or the test/server device 120 generates a video component based on the element IDs, the test steps and the text test.

After or simultaneously with the processor 204 of the test communication devices 101 or the test/server device 120 generating a video component based on the element IDs, the test steps and the text test at step 516, method 500 proceeds to step 520 where the processor 204 of the test communication devices 101 or the test/server device 120 generates an audio component based on the element IDs and the text test. After the processor 204 of the test communication devices 101 or the test/server device 120 generates an audio component based on the element IDs and the text test at step 520, method 500 proceeds to step 524 where the processor 204 of the test communication devices 101 or the test/server device 120 synchronizes the video component and the audio component based on the element IDs to create a video clip. After the processor 204 of the test communication devices 101 or the test/server device 120 synchronizes the video component and the audio component based on the element IDs to create a video clip at step 524, method 500 ends with the END operation at step 528.

Any of the steps, functions, and operations discussed herein can be performed continuously and automatically.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., a central processing unit (CPU), GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally, or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud,” multi-purpose processor array(s), cluster(s), etc.) and/or may be co-located with a microprocessor performing other processing operations. Any one or more microprocessors may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise, a CPU with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of FPGA, ROM, PROM, EPROM, RAM, bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users'premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as a Programmable Logic Device (PLD), a Programmable Logic Array (PLA), a FPGA, a Programmable Array Logic (PAL), special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or very-large-scale integration (VLSI) design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

A neural network, as described herein may comprise layers of logical nodes having an input and an output. If an output is below a self-determined threshold level, the output may be omitted (i.e., the inputs may be within an inactive response portion of a scale and provide no output), if an output is above the threshold, the output may be provided (i.e., the inputs may be within the active response portion of the scale and provide the output). The particular placement of active and inactive delineation may be provided as a step or steps. Multiple inputs into a node may produce a multi-dimensional plane (e.g., hyperplane) to delineate a combination of inputs that are active or inactive.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

The claims presented herein are to be interpreted in light of the specification and drawings presented herein with sufficiently narrow scope such as to preclude any basic mental process that could be performed entirely in the human mind. The claims presented herein are to be interpreted in light of the specification and drawings presented herein with sufficiently narrow scope such as to preclude any process that could be performed entirely by human manual effort.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A method for generating automated video tutorials, the method comprising:
receiving, by a processor, a test script document, wherein the test script document includes element identifiers, test steps and test text;
parsing, by the processor, the test script document to identify the element identifiers, the test steps and the test text;
generating, by the processor, a video component based on the identified element identifiers, the identified test steps and the identified test text;
generating, by the processor, an audio component based on the identified element identifiers, and the identified test text; and
synchronizing, by the processor, the video component and the audio component based on the identified element identifiers.

2. The method of claim 1, further comprising generating, by the processor, the audio component using text-to-speech.

3. The method of claim 1, further comprising receiving, by the processor, the test script document includes at least one of receiving the test script document via a network or receiving the test script document from a storage location at an associated address.

4. The method of claim 1, wherein the test script document is a text-based data structure.

5. The method of claim 1, further comprising, prior to generating, by the processor, the audio component based on the identified element identifiers and the identified test text, receiving a selection of one or more languages.

6. The method of claim 5, further comprising translating, by the processor, the test text based on the received selection of the one or more languages.

7. The method of claim 6, further comprising generating, by the processor, the audio component based on the translated test text based on the received selection of the one or more languages.

8. A computer system, comprising:
a processor; and
a computer-readable storage medium storing computer-readable instructions, which when executed by the processor, cause the processor to:
receive a test script document, wherein the test script document includes element identifiers, test steps and test text;
parse the test script document to identify the element identifiers, the test steps and the test text;
generate a video component based on the identified element identifiers, the identified test steps and the identified test text;
generate an audio component based on the identified element identifiers, and the identified test text; and
synchronize the video component and the audio component based on the identified element identifiers.

9. The computer system of claim 8, wherein the computer-readable instructions, when executed by the processor, further cause the processor to generate the audio component using text-to-speech.

10. The computer system of claim 8, wherein the computer-readable instructions, when executed by the processor, further cause the processor to receive a test script document includes at least one of receiving the test script document via a network or receiving the test script document from a storage location at an associated address.

11. The computer system of claim 8, wherein the test script document is a text-based data structure.

12. The computer system of claim 8, wherein the computer-readable instructions, when executed by the processor, further cause the processor to prior to generate the audio component based on the identified element identifiers and the identified test text, receive a selection of one or more languages.

13. The computer system of claim 12, wherein the computer-readable instructions, when executed by the processor, further cause the processor to translate the test text based on the received selection of the one or more languages.

14. The computer system of claim 13, wherein the computer-readable instructions, when executed by the processor, further cause the processor to generate the audio component based on the translated test text based on the received selection of the one or more languages.

15. A computer program product, comprising:
a computer-readable storage medium having computer-readable program code embodied therewith, the computer-readable program code configured, when executed by a processor, to:
receive a test script document, wherein the test script document includes element identifiers, test steps and test text;
parse the test script document to identify the element identifiers, the test steps and the test text;
generate a video component based on the identified element identifiers, the identified test steps and the identified test text;
generate an audio component based on the identified element identifiers, and the identified test text; and
synchronize the video component and the audio component based on the identified element identifiers.

16. The computer program product of claim 15, wherein the computer-readable program code, when executed by the processor, further causes the processor to generate the audio component using text-to-speech.

17. The computer program product of claim 15, wherein the computer-readable program code, when executed by the processor, further causes the processor to receive the test script document includes at least one of receiving the test script document via a network or receiving the test script document from a storage location at an associated address.

18. The computer program product of claim 15, wherein the test script document is a text-based data structure.

19. The computer program product of claim 15, wherein the computer-readable program code, when executed by the processor, further causes the processor to, prior to generate the audio component based on the identified element identifiers and the identified test text, receive a selection of one or more languages.

20. The computer program product of claim 19, wherein the computer-readable program code, when executed by the processor, further causes the processor to translate the test text based on the received selection of the one or more languages.
